(19) United States
(12) Patent Application Publication
(10) Pub. No.: US 2021/0279255 A1
(43) Pub. Date: Sep. 9, 2021

(54) SYNCHRONOUS STATE MACHINE REPLICATION FOR ACHIEVING CONSENSUS

(71) Applicant: VMware, Inc., Palo Alto, CA (US)

(72) Inventors: Kartik Ravidas NAYAK, Chapel Hill, NC (US); Ling REN, Champaign, IL (US); Dahlia MALKHI, Palo Alto, CA (US); Ittai ABRAHAM, Tel Aviv (IL)

(21) Appl. No.: 17/136,376

(22) Filed: Dec. 29, 2020

Related U.S. Application Data
(60) Provisional application No. 62/984,951, filed on Mar. 4, 2020.

(51) Int. Cl. G06F 16/27; G06F 16/23

(52) U.S. Cl. CPC G06F 16/275; G06F 16/2379

(57) ABSTRACT

A distributed service includes replicas that communicate with each other over a network to commit a block of client requests to a log of blocks of client requests. Each replica receives from one of the replicas, designated as the leader, a proposal for committing a new block to the log, and sends a vote on the proposed block to all of the other replicas via the network. Each replica then starts a timer set to twice the maximum network delay time to transmit messages over the network. If there is no equivocation when the timer lapses or stalling condition in proposing new blocks, then each replica commits the proposed block to the log. If there is equivocation or stalling condition, then a new leader is selected, and the process re-attempts to commit the proposed block.

### CROSS-REFERENCE TO RELATED APPLICATION(S)

This application claims the benefit of U.S. Provisional Application No. 62/984,951, filed Mar. 4, 2020, which is incorporated by reference herein.

### BACKGROUND

Distributed computing systems with multiple cooperating agents, some of which may be faulty, rely on consensus protocols to come to an agreement on a data value needed by each agent. A consensus protocol must satisfy the following properties: (a) every correct agent agrees on the same value (Safety); and (b) every correct agent eventually decides on some value (Liveness). A workable protocol guarantees safety and liveness despite some limited number of faulty agents.

Consensus protocols can be either synchronous or asynchronous. Asynchronous protocols are those in which each agent operates without reference to any strict arrival time of signals or messages. In contrast, synchronous protocols operate in lockstep with a clock, and partially synchronous protocols observe certain strict bounds on arrival times of signal or messages.

Asynchronous protocols have typically suffered from a limited (less than ⅓ of the total number n of agents) tolerance of faulty and/or malicious agents (sometimes called Byzantine agents). Synchronous protocols have a greater tolerance to faulty agents (less than ½ of n) but have been considered impractical because they require a large number of iterations (rounds) and require lockstep execution of each agent. Additionally, they may be subject to an attack that violates the synchrony assumption, making them unsafe.

A consensus protocol is commonly implemented in replicated state machines. In this implementation, each agent (now called a replica) has an identical state machine that handles local inputs and outputs and transitions that occur in the protocol.

The data value that is decided on by the consensus protocol can either be a single data value or a fixed number of values gathered into a block. Additionally, each block agreed on by the replicas can be recorded into a linear log that is maintained by each replica so that each replica has the same view of all of the blocks agreed on up to a given time. A linear log of blocks is sometimes referred to as a blockchain, and the consensus protocol guarantees its integrity. Blockchain consensus protocols include the Nakamoto protocol and the Practical Byzantine Fault Tolerance (PBFT) protocol. Each of these protocols has certain deficiencies. The Nakamoto protocol implemented in the Bitcoin application uses a costly proof-of-work mechanism to decide to add blocks to the chain, giving the protocol low throughput and high latency. The PBFT protocol uses four phases and two or more rounds to reach an agreement about a block to add to the chain, giving the protocol low throughput and high latency.

What is needed is a protocol that can tolerate a larger number of faulty replicas but has fewer rounds, high throughput, and low latency.

### SUMMARY

One embodiment includes a method for committing a block of client requests to a log of committed blocks in a distributed service that comprises N replicas deployed on compute nodes of a computer network, where N is a positive integer. The method includes receiving from one of the N replicas a proposal for committing to the log a block of client requests, sending a vote on the proposed block to all of the replicas, setting a timer to a delay that is twice a maximum transmission delay between any two compute nodes on the computer network and starting the timer. If there is neither an equivocation during the timer delay nor a stalling condition, the proposed block is committed to the log if each replica is a prompt replica, which is a replica that responds to messages within the delay of the timer.

Further embodiments include, without limitation, a non-transitory computer-readable storage medium that includes instructions for a processor to carry out the above method, and a computer system that includes a processor programmed to carry out the above method.

### BRIEF DESCRIPTION OF THE DRAWINGS

FIG. 1A depicts a block diagram of a computer system in which one or more embodiments may be implemented.

FIG. 1B depicts a block diagram of a computer system in which one or more embodiments may be implemented.

FIG. 2A is a diagram depicting a network of replicas.

FIG. 2B is a diagram depicting the structure of a block, according to embodiments.

FIG. 3 depicts the flow of operations for the main program for each replica, according to embodiments.

FIG. 4 depicts the flow of operations for the Propose function, in a first embodiment.

FIG. 5 depicts the flow of operations for the Vote function, in the first embodiment.

FIG. 6 depicts the flow of operations for the Pre-commit function, in the first embodiment.

FIG. 7 depicts the flow of operations for the Commit function, in the first embodiment.

FIG. 8 depicts the flow of operations for the View Change function, in the first embodiment.

FIG. 9 depicts the flow of operations for the Blame function, in the first embodiment.

FIG. 10 depicts the flow of operations for the Quit_old_view function, in the first embodiment.

FIG. 11 depicts the flow of operations for the Status function, in the first embodiment.

FIG. 12 depicts the flow of operations for the Vote function, in a second embodiment.

FIG. 13 depicts the flow of operation for the Pre-commit function, in the second embodiment.

FIG. 14 depicts the flow of operations for the Commit function, in the second embodiment.

FIG. 15 depicts the flow of operations for the Vote function, in a third embodiment.

FIG. 16 depicts the flow of operations for the Pre-commit function, in the third embodiment.

FIG. 17 depicts the flow of operations for the Quit_old_view function, in the third embodiment.

FIG. 18 depicts the flow of operations for the Status function, in the third embodiment.

FIG. 19 depicts the flow of operations for the Propose function, in a fourth embodiment.

FIG. 20 depicts the flow of operations for the Vote function, in the fourth embodiment.

FIG. 21 depicts the flow of operations for the Pre-commit function, in the fourth embodiment.

FIG. 22 depicts the flow of operations for the Commit function, in the fourth embodiment.

FIG. 23 depicts the flow of operations for the View Change function, in the fourth embodiment.

FIGS. 24A and 24B depict the flow of operations for the BlameAndQuitView function, in the fourth embodiment.

FIG. 25 depicts the flow of operations for the Status function, in the fourth embodiment.

FIG. 26 depicts the flow of operations for the New-View function, in the fourth embodiment.

FIG. 27 depicts the flow of operations for the First Vote function, in the fourth embodiment.

FIG. 28 depicts the flow of operations for the Vote function, in a fifth embodiment.

FIG. 29 depicts the flow of operations for the Pre-commit function, in the fifth embodiment.

FIG. 30 depicts the flow of operations for the Commit function, in the fifth embodiment.

FIG. 31 depicts the flow of operations for the Pre-commit function, in a sixth embodiment.

FIGS. 32A and 32B depict the flow of operations for the BlameAndQuitView function, in the sixth embodiment.

FIG. 33 depicts the flow of operations for the Status, in the sixth embodiment.

FIG. 34 depicts the flow of operations for the New-view function, in the sixth embodiment.

FIG. 35 depicts the flow of operations for the First Vote function, in the sixth embodiment.

### DETAILED DESCRIPTION

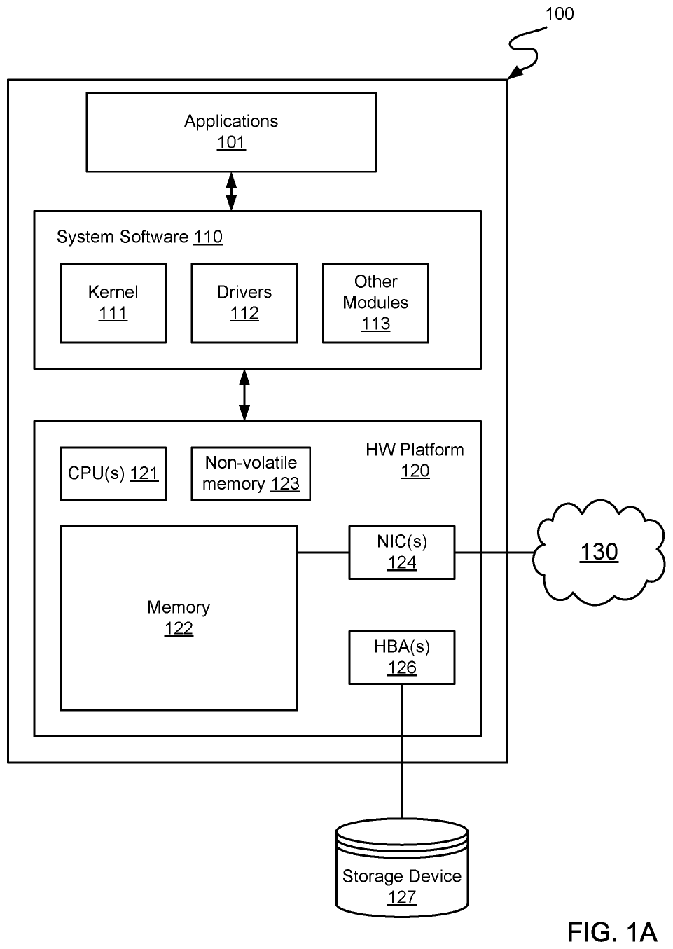

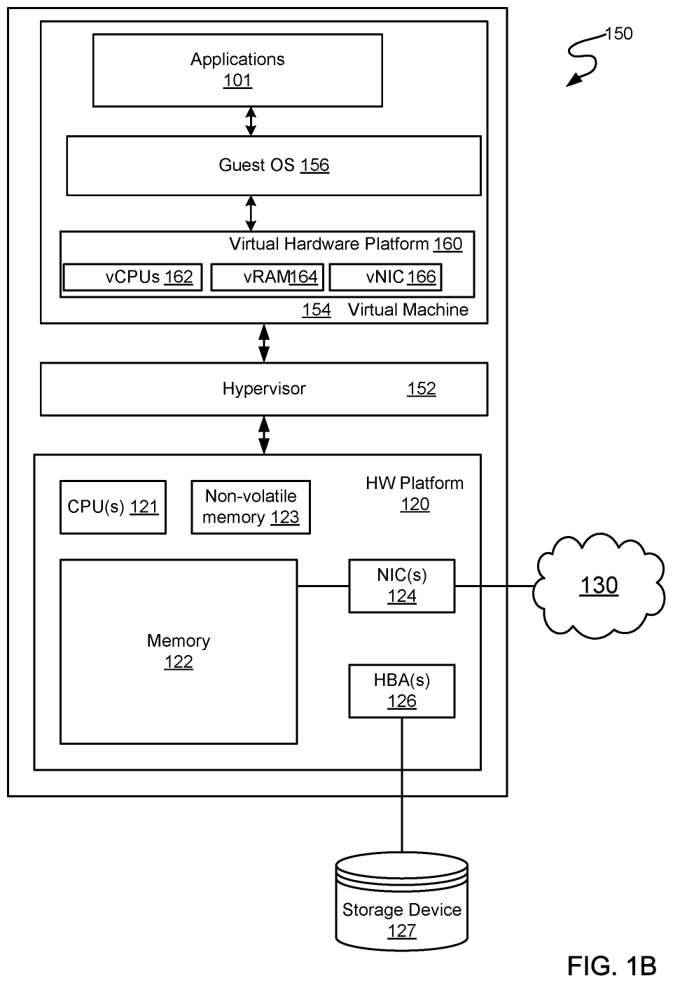

FIG. 1A depicts a block diagram of a computer system 100 in which one or more embodiments may be implemented. Computer system 100 includes one or more applications 101 that are running on top of system software 110. System software 110 includes a kernel 111, drivers 112, and other modules 113 that manage hardware resources provided by a hardware platform 120. System software 110 is an operating system (OS), such as operating systems that are commercially available. Hardware platform 120 includes one or more physical central processing units (pCPUs) 121, system memory 122 (e.g., dynamic random access memory (DRAM)), read-only memory (ROM) 123, one or more network interface cards (NICs) 124 that connect computer system 100 to a network 130, and one or more host bus adapters (HBAs) 126 that connect to storage device(s) 127, which may be a local storage device or provided on a storage area network.

Computer system 100 may correspond to a replica in a group of replicas to be described below in which NICs 124 may be used to communicate with other replicas in the group of replicas via network 130, according to one or more embodiments.

FIG. 1B depicts a block diagram of a computer system in which one or more embodiments may be implemented. Computer system 150 includes one or more applications 101 running on a guest operating system 156 in a virtual machine 154. A hypervisor 152 that supports one or more virtual machines 154 running thereon, e.g., a hypervisor that is included as a component of VMware's vSphere® product, is commercially available from VMware, Inc. of Palo Alto, Calif. Hardware platform 120 is the same as hardware platform 120 in FIG. 1A. Hypervisor 152 supports a virtual hardware platform 160 of virtual machine 154. Virtual hardware platform 160 includes one or more virtual CPUs 162, vRAM 164, and a vNIC 166.

Computer system 150 may correspond to a replica in a group of replicas to be described below in which NICs 124 may be used to communicate with other replicas in the group of replicas via network 130, according to one or more embodiments.

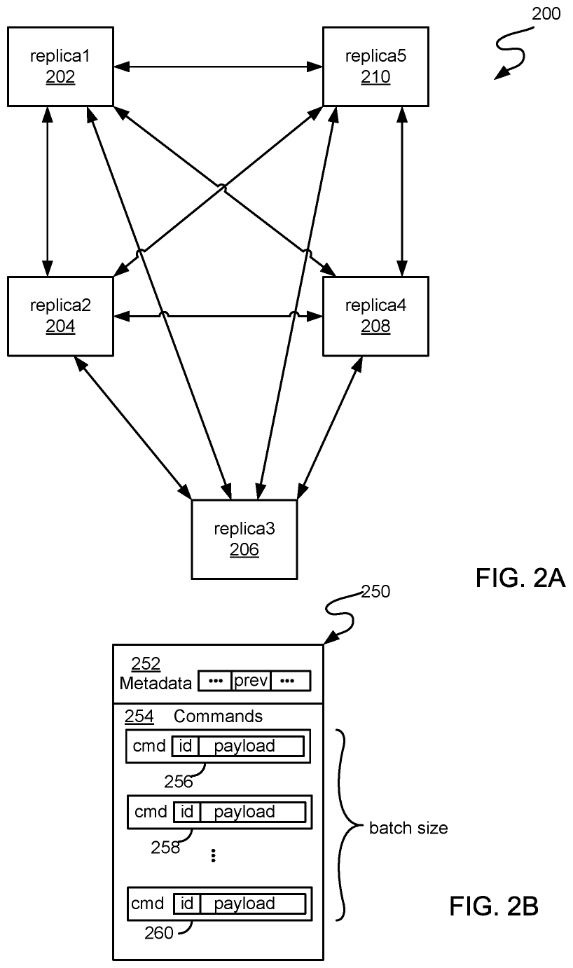

FIG. 2A depicts a network of connected replicas. Replicas 202, 204, 206, 208, 210 are connected pairwise in a network 200 over authenticated communication channels. A delta time Δ denotes a known maximum network transmission delay in the network, though the actual transmission delay may be smaller than the delta time Δ. There are n replicas, of which up to f may be faulty. The other replicas are called honest replicas. The replicas designate one of the replicas at a particular time as the leader whose identity is given by a view number, v. The leader is expected to make progress by committing client requests into the log in a consistent manner. If not, then the leader is replaced by a new leader. New leaders may be selected in ascending order of the replicas, modulo the number of replicas.

In one embodiment, a replica is implemented on a virtual machine. The virtual machine has 16 virtual CPUs assigned to it, has a maximum TCP bandwidth of about 9.6 Gbps (gigabits per second), and a network latency between two virtual machines of less than 1 millisecond. The maximum time for a message on the network between virtual machines is 50 milliseconds.

Client requests or commands are batched (grouped) into blocks, where a block is a tuple (bₖ, H(Bₖ₋₁)) that includes the proposed value of the block bₖ and a hash digest H(Bₖ₋₁) of a predecessor block, where H is the hash function.

The structure of a block is depicted in FIG. 2B. Each block 256, 258, 260 contains a batch of commands sent by clients. A command consists of a unique identifier, id, and an associated payload. The maximum number of commands in a block is the batch size. In one embodiment, the batch size ranges from 400 to 800 items.

Blocks are organized into a chain of blocks, and the position in the chain of a block is called its height k. A block Bₖ is said to extend a block Bₗ if Bₗ is an ancestor of block Bₖ, and two blocks Bₖ and B_{k′} are said to conflict or equivocate with each other if they do not extend one another. A set of signed votes on a block from a quorum of replicas is a quorum certificate. A quorum consists of f+1 replicas out of a total of 2f+1. If a block Bk has a quorum certificate in a view, then it is a certified block designated as Cᵥ(Bₖ). Certified blocks are ranked first by their view number and then by their height in the chain. Certified blocks can be locked-on by a replica at the beginning of a view.

### First Embodiment

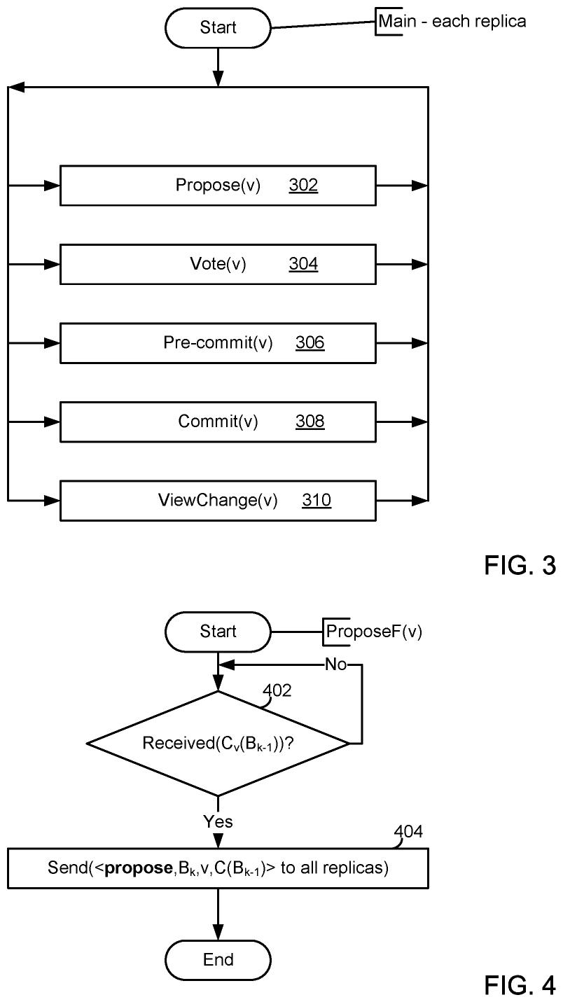

FIGS. 3-7 depict the first embodiment, which is called the steady-state protocol.

FIG. 3 depicts the flow of operations of the main program for each replica, according to embodiments. As depicted, each replica 202-210 is cable of performing the Propose function 302, Vote function 304, Pre-commit function 306, Commit function 308, and View Change function 310 according to the circumstances. The flow of operations depicted indicates that each function, if it runs, does so concurrently with the other functions, thereby allowing a replica to work on the next block without waiting for a previous block to be committed.

FIG. 4 depicts the flow of operations for the Propose function, in a first embodiment. In Propose function 302, if the replica is the leader, then upon receipt of a certified block (Cᵥ(Bₖ₋₁)) in step 402, the replica sends in step 404 a propose message <propose, Bₖ, v, C(Bₖ₋₁)> to all replicas (i.e., broadcasts the propose message) in which the proposed block Bₖ extends the highest certified block. If the replica is not the leader, then Propose function 302 is skipped for that replica.

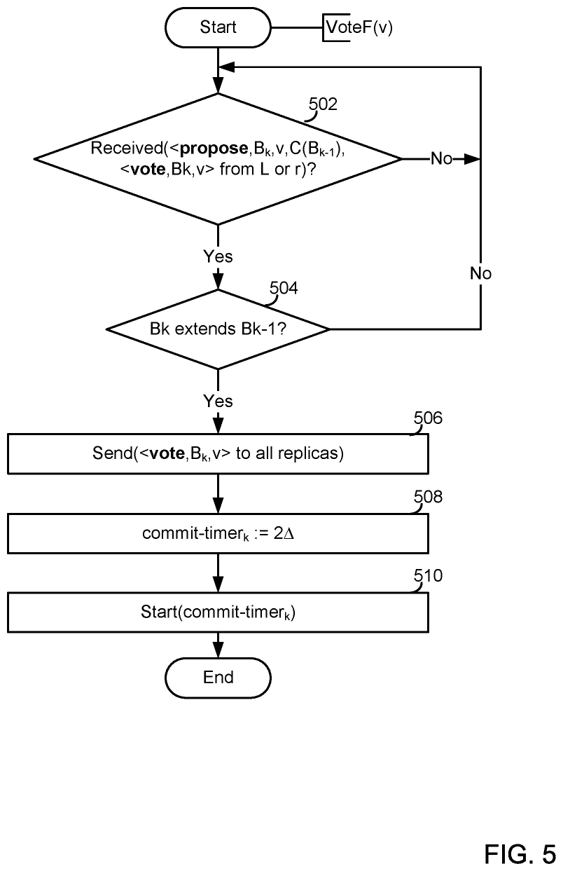

FIG. 5 depicts the flow of operations for the Vote function 304, in the first embodiment. In Vote function 304, each replica, upon receiving in step 502 a propose message <propose, Bₖ, v, C(Bₖ₋₁)> for a block Bₖ that extends the previous block Bₖ₋₁, as determined in step 504, sends in step 506 a vote message <vote, Bₖ, v> for that block to all replicas (broadcasts the vote). The broadcast of the vote starts a commit timer (commit-timerₖ) in step 510 for the block, which is set in step 508 to a value of 2Δwhere Δ is the maximum time for communication in the network of replicas.

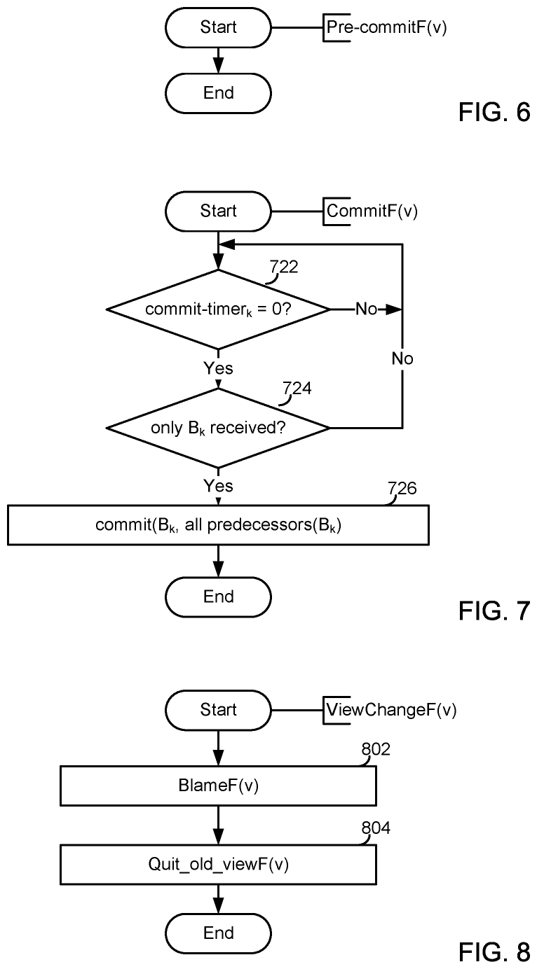

FIG. 6 depicts the flow of operations for the Pre-commit function, in the first embodiment. Pre-commit function 306 is skipped in the first embodiment.

FIG. 7 depicts the flow of operations for the Commit function, in the first embodiment. Commit function 308 waits in step 722 for the commit-timer for the block to elapse. If no equivocation occurs, i.e., only Bₖ is received as determined in step 724, then the function commits the Bₖ block and all of its predecessors in step 726.

As long as there is no equivocation or stalling, the protocol operates using only the Propose (only by the leader) function 302, Vote function 304, and Commit function 308. If equivocation or stalling occurs, then View Change function 310 is employed to change the leader.

FIGS. 8-11 the View Change function for the steady-state protocol.

FIG. 8 depicts the flow of operations for the View Change function, in the first embodiment. View Change function 310 determines whether or not the protocol has been disturbed during the commit time period, which upsets the safety or liveness assumptions of the protocol. The disturbance may either be a stall, in which no progress is made, or an equivocation in which a block not extending the previously committed block is proposed. To perform these determinations, ViewChange function 310 executes a Blame function in step 802 and a Quit_old_view function in step 804.

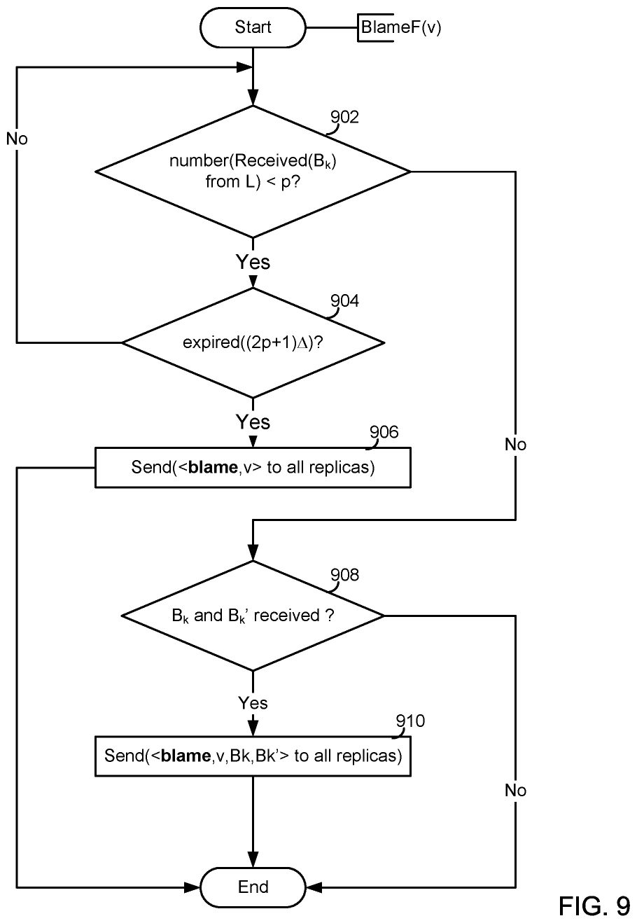

FIG. 9 depicts the flow of operations for the Blame function, in the first embodiment. The Blame function determines that a stall has occurred by waiting for a time (2p+1)Δ in step 904 during which the number of blocks received from the leader is less than p as determined in step 902. If such a condition occurs, then the function sends a <blame, v> message to all replicas in step 906. The Blame function determines in step 908 that an equivocation occurs if a block Bk and Bk′ have been received where B_{k′} does not extend Bₖ (or vice-versa). If such a condition occurs, then the function sends a <blame, v, Bₖ, B_{k′}> to all replicas in step 910.

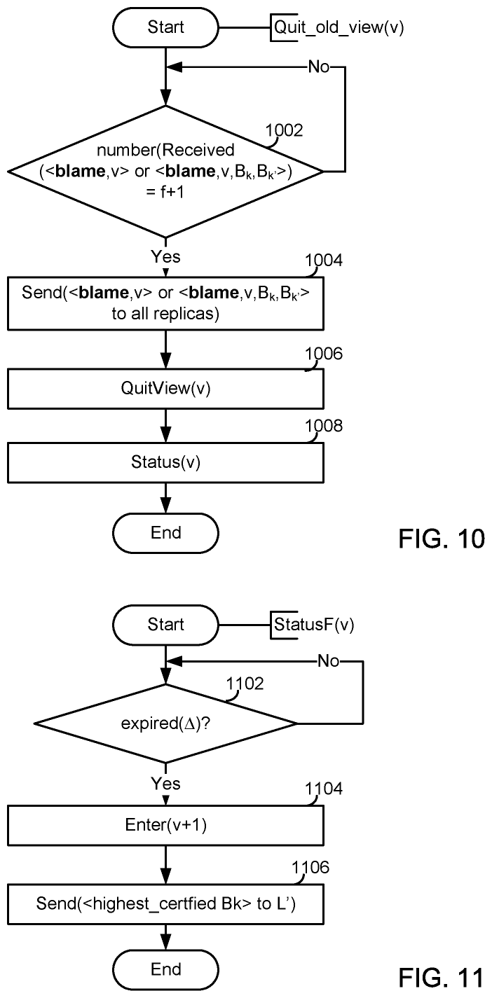

FIG. 10 depicts the flow of operations for the Quit_old_view function, in the first embodiment. The Quit_old_view function determines whether a certain number of blame messages has occurred in step 1002. Specifically, if the number of <blame, v> or <blame, v, Bₖ, B_{k′}> messages received by a replica is equal to f+1, then the function sends (forwards) the blame message to all replicas in step 1004 and performs a QuitView function in step 1006. After performing the QuitView function, which aborts all of the commit-timers and stops all voting in the current view, thereby stopping all commit operations, the function calls the Status function in step 1008.

FIG. 11 depicts the flow of operations for the Status function, in the first embodiment. The Status function waits for a Δ time in step 1102 and then enters a new view, v+1, in step 1104, after which the function sends a message in step 1106 with the highest certified block Bₖ to the new leader L′. The Status function helps to assure that the new leader L′ proposes a new block that extends the highest certified block Bₖ.

The protocol of the first embodiment guarantees both safety and liveness. Safety is guaranteed because honest replicas always commit the same block Bₖ for each height k. The safety guarantee depends on the fact that if an honest replica directly commits a block Bₗ in a view, then there does not exist C(B_{l′}) where B_{l′}≠Bₗ.

Liveness is guaranteed because (i) a view change does not happen if the current leader is honest; (ii) a faulty leader must propose p blocks in (2p+1)Δ time to avoid a view change; and (iii) if k is the highest height at which some honest replica has committed a block in view v, then leaders in subsequent views must propose blocks at heights higher than k. The liveness guarantee depends on the fact that if an honest replica directly commits a block Bₗ in a view, then (i) every honest replica votes for Bₗ in that view, and (ii) every honest replica receives C(Bₗ) before entering the next view.

Throughput in the steady-state is high and similar to partially synchronous protocols because the commit function is non-blocking, which means that a new proposal can be acted upon while a current proposal is in process.

Latency in the steady-state from a leader's perspective is 2Δ+4δ, where Δ is the maximum network delay, and δ is the actual network delay.

### Second Embodiment

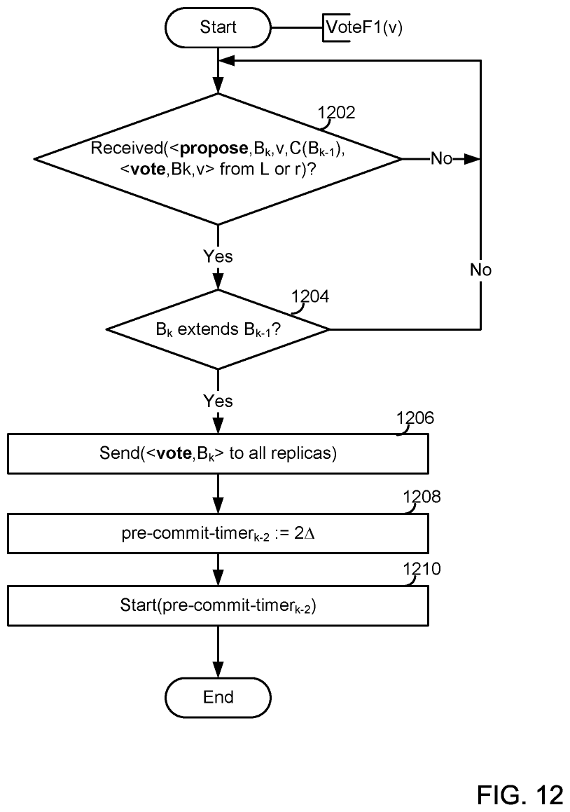

FIGS. 12-14 depict the flow of operations for the second embodiment, which is called the steady-state protocol for mobile, sluggish replicas.

The second embodiment modifies the first embodiment to allow for communications between replicas, which may be delayed for longer than a Δ time due to a temporary loss in network connectivity. A replica is denoted as sluggish if it does not respond within a Δ time, and a prompt replica is one that does respect the Δ time.

In the case of sluggish replicas, safety cannot be guaranteed because a sluggish replica may not receive a certificate in the 2Δ time period, other replicas may not receive the sluggish replica's votes and resulting certificates and, the replica may not receive an equivocation in time if there is one.

The total number of faulty replicas allowed includes sluggish replicas. Thus, if the number of sluggish replicas is d and the number of faulty replicas is b, then the total number of faulty replicas that can be tolerated is f=d+b. For example, if the total number of replicas is 5, then f=2, and only one sluggish replica and one faulty replica can be tolerated, and the remaining three replicas are prompt replicas.

To handle sluggish replicas, Vote function 304, Pre-commit function 306, and Commit function 308 are modified according to FIGS. 12-14. A Pre-commit function 306 now waits for a 2Δ time, which Vote function 304 initiated so that Commit function 308 can instead test the number of commit messages received.

FIG. 12 depicts the flow of operations for the Vote function, in the second embodiment. Vote function 304 is modified to use a pre-commit-timer for the block Bₖ₋₂. The pre-commit timer is set to a value of 2Δ in step 1208 and started after the replica broadcasts its vote in step 1210. Steps 1202, 1204, and 1206 are the same as steps 502, 504, and 506 in the Vote function of FIG. 5.

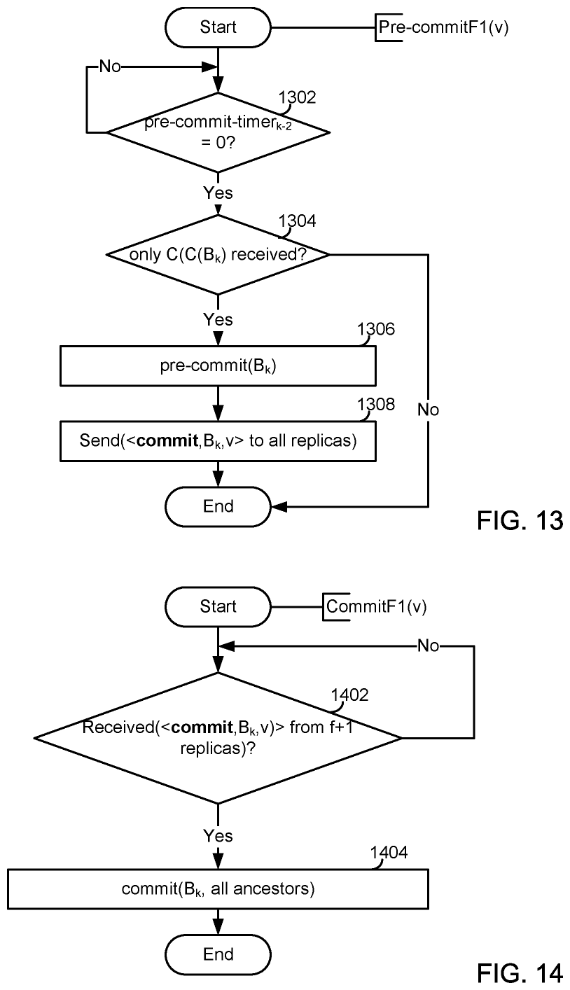

FIG. 13 depicts the flow of operation for the Pre-commit function, in the second embodiment. Pre-commit function 306 operates using the pre-commit-timer that was set in the Vote function 304. Specifically, if during the pre-commit-timer interval, only one certified block C(Bₖ) is received as determined by steps 1302 and 1304 and certified (no equivocation occurs) in step 1304, then the function pre-commits the block Bk in step 1306. After the pre-commit, the function sends a <commit, Bk, v> message to all replicas in step 1308.

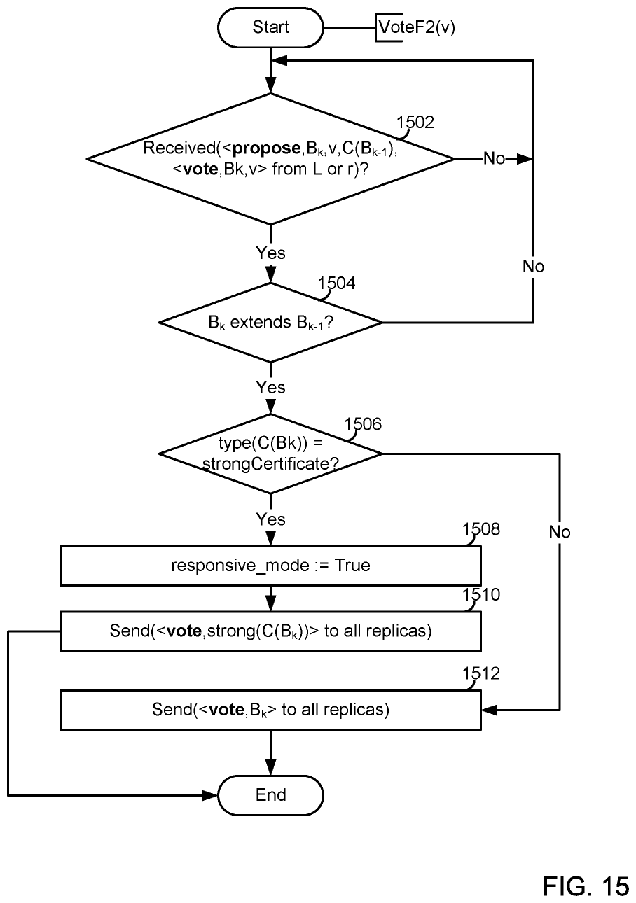

FIG. 14 depicts the flow of operations for the Commit function, in the second embodiment. Instead of using a timer, Commit function 308 awaits the receipt of <commit, Bₖ, v> messages from f+1 honest replicas in step 1402, after which it commits the block Bₖ and all of its ancestors in step 1404. Receiving commits from the honest replicas for an undisturbed 2Δ period assures that an equivocation could not have been missed and that the commit is safe.

Thus, the modification to the first embodiment guarantees safety because honest replicas always commit the same block Bk for each height. Liveness is guaranteed only during periods in which all honest replicas stay prompt.

The total latency for the second embodiment is 2Δ+9δ.

### Third Embodiment

FIGS. 15-18 depict the flow of operations of the third embodiment, which is called the steady-state protocol with responsive mode.

The third embodiment is capable of operating in a responsive mode in which the commit latency depends on δ (the actual network delay) instead of the maximum network delay Δ. Operating in the responsive mode requires modifications to the functions of the second embodiment. In particular, the Vote function, the Pre-commit function, and the ViewChange function are modified.

FIG. 15 depicts the flow of operations for the Vote function, in the third embodiment. If Vote function 304 receives a propose message <propose, Bₖ, v, C(Bₖ₋₁)> or a vote message <vote, Bₖ, v> and if the proposed block Bk extends the previous block Bₖ₋₁, as determined in steps 1502 and 1504, then the function additionally determines whether the type of block Bₖ received contains a strong certificate for its predecessor in step 1506 and if so, sets the mode to responsive_mode in step 1508, after which it only votes for blocks with strong certificates for the rest of the view in step 1510.

If the type of block received does not contain a strong certificate as determined in step 1506, then the function sends a <vote, Bₖ> message to all replicas in step 1512, as in the second embodiment.

Additionally, Vote function 304 does not initiate any timer. Instead, the 2Δ timer is moved to Pre-commit function 306.

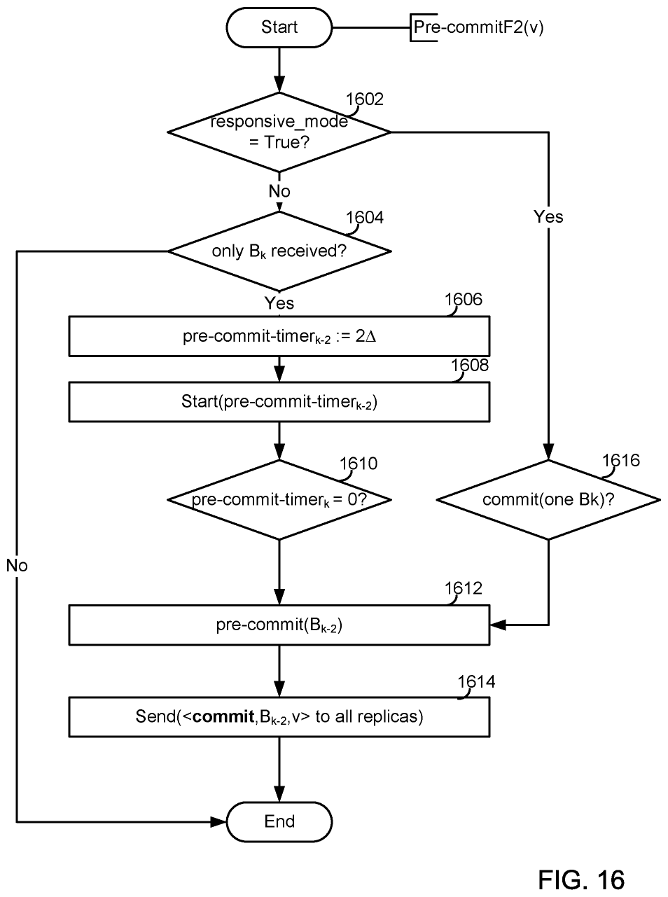

FIG. 16 depicts the flow of operations for the Pre-commit function, in the third embodiment. Pre-commit function 306 operates in either the responsive mode or the non-responsive mode.

In the non-responsive mode, as determined by step 1602, the function sets a pre-commit-timer for block Bₖ₋₂ and starts the pre-commit-timer in step 1608. If, when the pre-commit timer elapses in step 1610, only one block Bk is received as determined by steps 1604, 1606, and 1608, the function pre-commits block Bₖ₋₂ in step 1612 and sends a <commit, Bₖ₋₂, v> message to all replicas in step 1614. Receiving only one block Bk during the timer interval as determined by step 1616 assures there is no equivocation.

If one block is committed in the responsive mode, then the switch to responsive mode is confirmed, as determined by steps 1602 and 1616. Committing the one block ensures that most replicas have switched to the responsive mode. The function then pre-commits block Bₖ₋₂ in step 1612 and sends a <commit, Bₖ₋₂, v> message to all replicas in step 1614. No 2Δ timer is involved in the responsive mode.

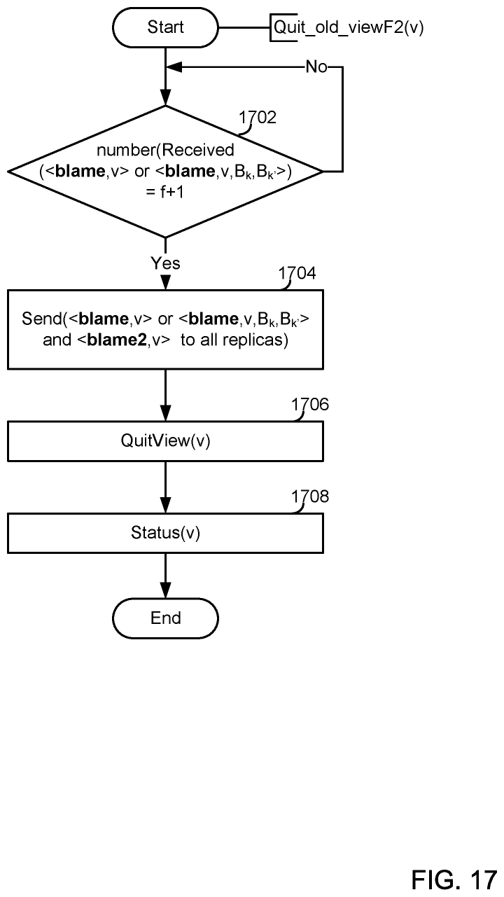

FIG. 17 depicts the flow of operations for the Quit old view function, in the third embodiment. The Quit old view function of View Change function 310 is altered to send not only the <blame, v> or <blame, v, Bₖ, B_{k′}> messages but also a <blame2, v> message to all replicas in steps 1702 and 1704. The blame and blame2 messages implement a two-phase blame function which assures that all replicas move to the new view together. Steps 1706 and 1708 are the same as steps 1006 and 1008 in FIG. 10.

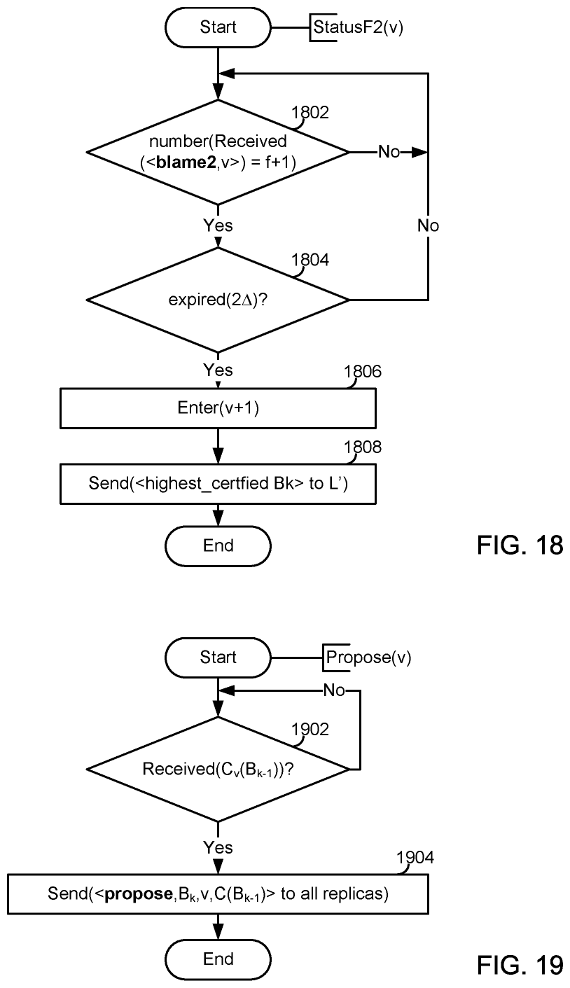

FIG. 18 depicts the flow of operations for the Status function, in the third embodiment. The Status function in ViewChange function 310 is altered. If the number of <blame2, v> messages received is f+1 over a period of 2Δ, as determined in step 1802 and 1804, then the function enters a new view (v+1) in step 1806 and sends the highest certified block Bₖ to the new leader L′ in step 1808. The 2Δ delay is introduced at a replica after learning that a majority of replicas have quit the view to give the replica sufficient time for the certificates to be sent across to a majority of prompt replicas before they enter and subsequently vote in the next view.

Both safety and liveness are guaranteed in the third embodiment for reasons similar to those given in regard to the first embodiment.

### Fourth Embodiment

FIGS. 19-22 refer to the flow of operations for the fourth embodiment, which is called the steady-state protocol under standard synchrony.

FIG. 19 depicts the flow of operations for the Propose function, in the fourth embodiment. In Propose function 302, if the replica is the leader, then upon receipt of a certified block Cᵥ(Bₖ₋₁) in step 1902, the replica sends a propose message <propose, Bₖ, v, C(Bₖ₋₁)> to all replicas in step 1904 where block Bk extends the highest certified block Cᵥ(Bₖ₋₁). If a replica is not the leader, then the Propose function is skipped.

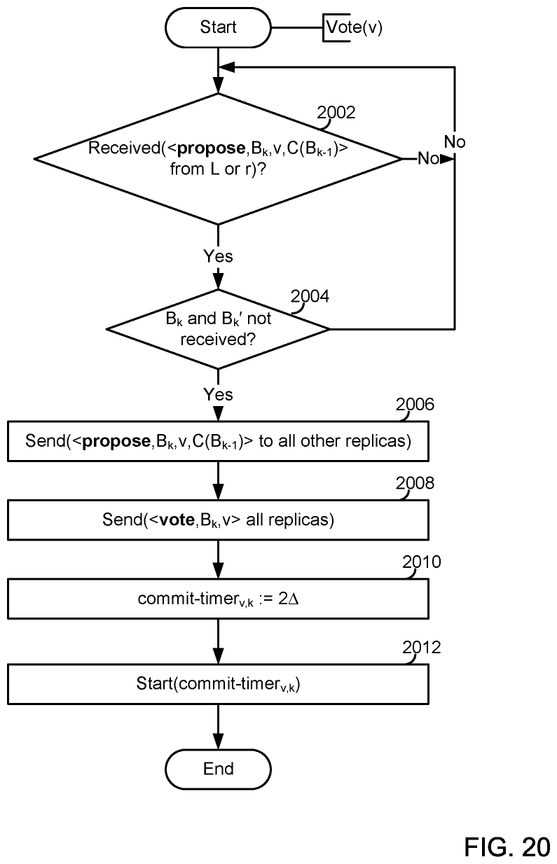

FIG. 20 depicts the flow of operations for the Vote function, in the fourth embodiment. In Vote function 304, each replica receives a propose message <propose, Bₖ, v, C(Bₖ₋₁)> for a block in step 2002 if there is no equivocation as determined in step 2004, sends (forwards) the propose message in step 2006. The function then broadcasts a vote message <vote, Bₖ, v> for that block in step 2008. In step 2010, the function sets a commit-timer_{v,k} to a value of 2Δ, where Δ is the maximum time for communication in the network of replicas and starts the timer in step 2012.

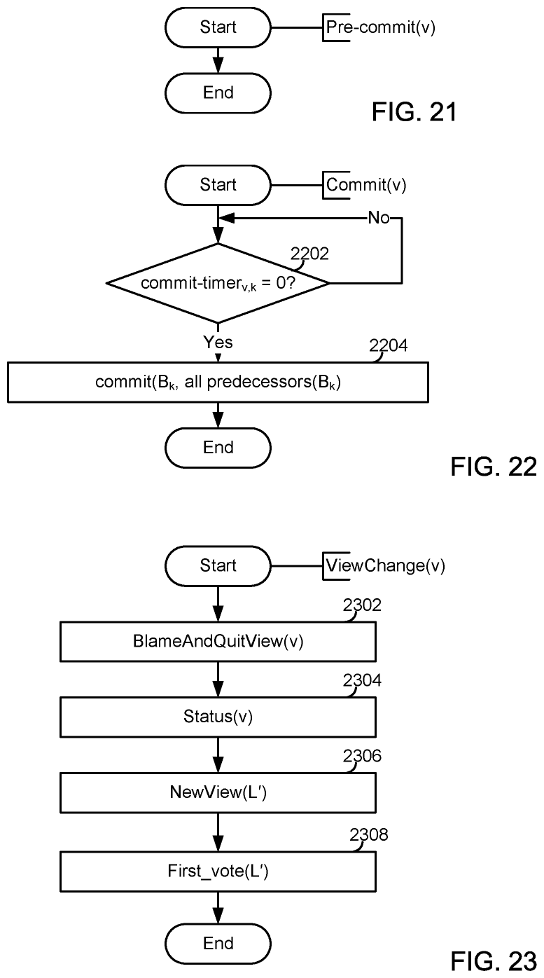

FIG. 21 depicts the flow of operations for the Pre-commit function, in the fourth embodiment. Pre-commit function 306 is skipped in the fourth embodiment.

FIG. 22 depicts the flow of operations for the Commit function, in the fourth embodiment. Commit function 308 waits for the commit timer for the proposed block to elapse in step 2202, after which the function commits the proposed block Bₖ in step 2204. The commit causes the proposed block and all of its predecessors to be committed to the log.

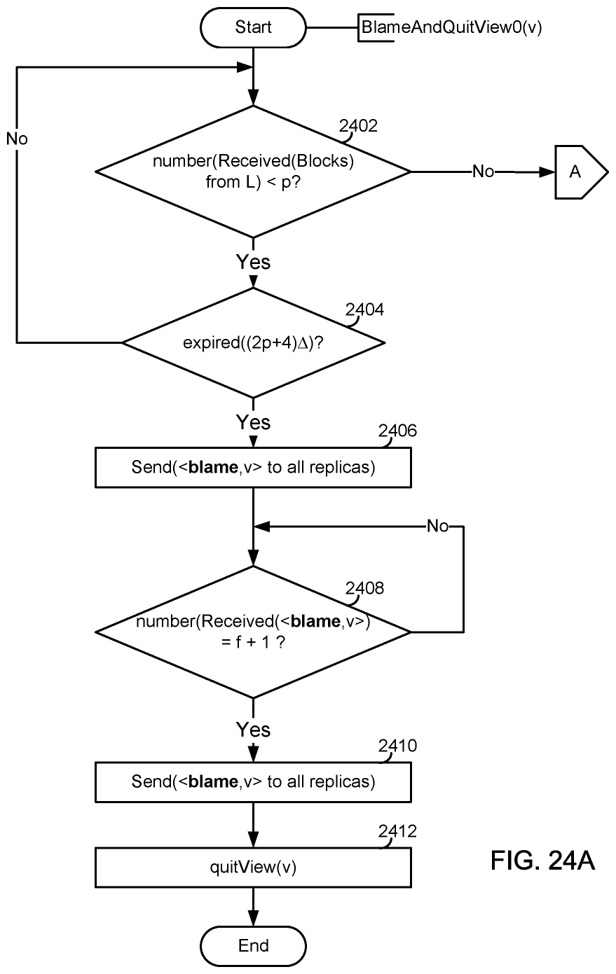

FIGS. 23-27 refer to the view-change protocol under standard synchrony in the fourth embodiment.

FIG. 23 depicts the flow of operations for the View Change function, in the fourth embodiment. View Change function 310 determines whether the protocol is stalled (no progress made in a given time period) or has exhibited equivocation. Both stalling and equivocation disturb the safety and liveness of the standard synchrony protocol and thus require a new leader to be selected to remedy the disturbance. ViewChange function 310 invokes a BlameAndQuitView function in step 2302, a Status function in step 2304, a New-view function in step 2306, and a First-vote function in step 2308.

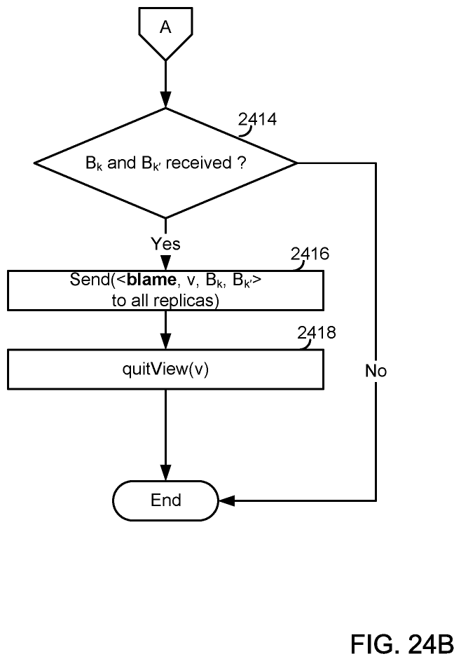

FIGS. 24A and 24B depict the flow of operations for the BlameAndQuitView function, in the fourth embodiment. The BlameAndQuitView function detects whether either a stall or an equivocation has occurred.

A stall occurs when the number of received blocks from the leader is less than p over a time of (2p+4)Δ as determined in steps 2402 and 2404. Equivocation occurs when conflicting blocks are present during the view, where a conflicting block does not extend another block.

If a stall condition occurs, then the function sends a blame message <blame, v> to all of the replicas in step 2406, and if the number of blame messages received is f+1 as determined in step 2408, then the function sends the blame message <blame, v> to all replicas in step 2410 and quits the current view v in step 2412.

If an equivocation condition occurs as determined in step 2414 of FIG. 24B, then the function sends a blame message <blame, v, Bₖ, B_{k′}> in step 2416, including the equivocating blocks Bₖ and B_{k′}, to all replicas and quits the current view in step 2418.

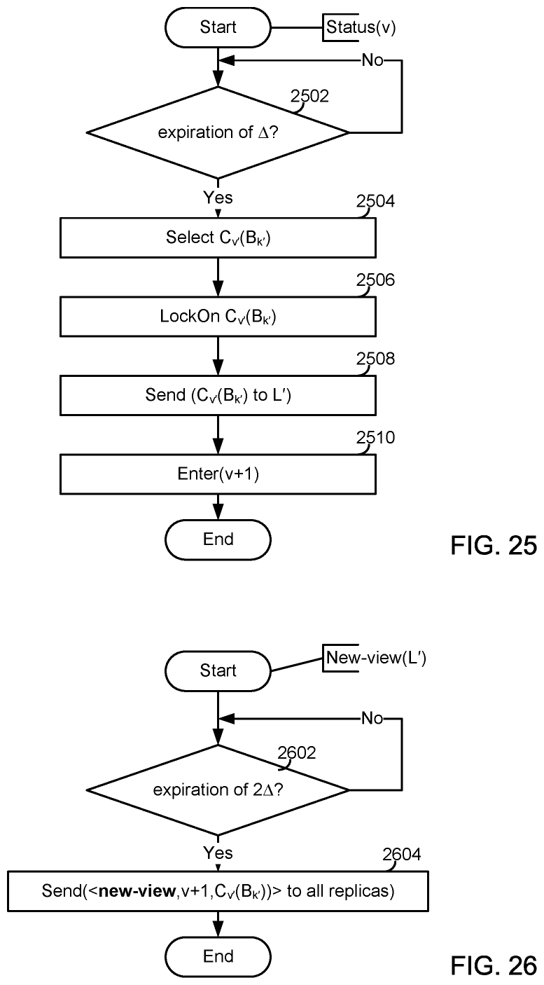

FIG. 25 depicts the flow of operations for the Status function, in the fourth embodiment. The Status function first waits for a Δ time in step 2502 and then selects the highest certified block (Cv(Bk′)) in step 2404. The function then locks-on to the selected block in step 2506, sends the selected block in step 2508, and enters the new view, v+1, in step 2510.

FIG. 26 depicts the flow of operations for the New-View function, in the fourth embodiment. The New-View function first waits in step 2602 for a 2Δ time after the new view v+1 is entered, and then sends a new-view message <new-view, v+1, Cᵥ(B_{k′})> in step 2604 to all of the replicas.

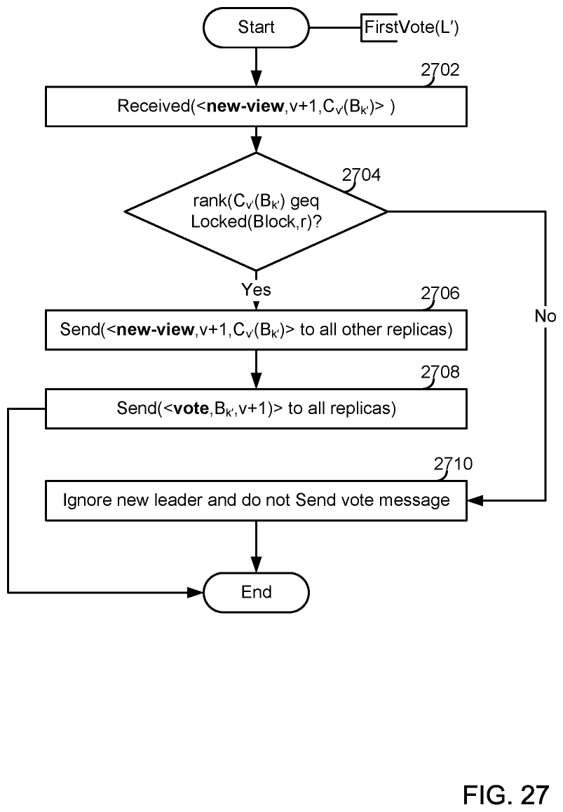

FIG. 27 depicts the flow of operations for the First Vote function, in the fourth embodiment. The First Vote function receives a new-new view message <new-view, v+1, Cᵥ(B_{k′})> in step 2702 and compares ranks of the highest certified block C_{v′}(B_{k′}) and the block that was locked-on in FIG. 10 in step 2704. If the rank is greater than or equal to the locked-on block as determined in step 2704, then the function sends a new-view message <new-view, v+1, Cᵥ(B_{k′})> in step 2706 to all other replicas and sends a vote message <vote, Bₖ, v+1> to all of the replicas in step 2708. If the rank is less than the locked-on block as determined in step 2704, then the function ignores the new leader and does not send a vote message in step 2710.

Safety and liveness are guaranteed. Safety is guaranteed because no two honest replicas can commit to different blocks at the same height. The guarantee is based on the fact that if an honest replica directly commits a block Bₗ in view v, then any certified block that ranks equal to or higher than Cᵥ(Bₗ) must extend Bₗ.

Liveness is guaranteed because all honest replicas keep committing new blocks. If a faulty leader fails to make at least p proposals within a (2p+4)′ time, then a view change occurs, and eventually, an honest leader is chosen, which will keep committing new blocks.

The throughput of the first embodiment is similar to partially synchronous protocols. Latency of the first embodiment to commit a block from the leader's perspective is 2Δ+δ after the block is proposed.

### Fifth Embodiment

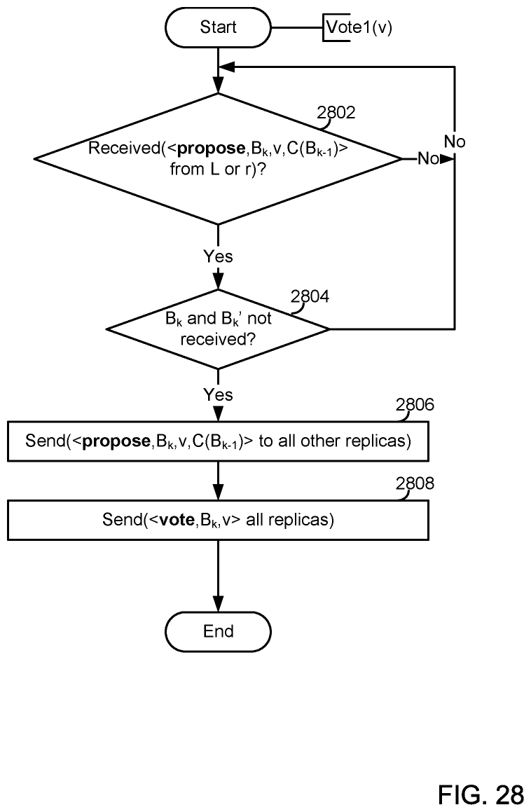

FIGS. 28-30 refer to the flow of operations for the fifth embodiment, which is called the steady-state protocol with mobile, sluggish faults. A sluggish replica is one that does not or cannot respond to a message in the network within a Δ time due to a temporary loss in network connectivity. A replica that responds within a Δ time or one that recovers from the temporary loss in network connectivity is denoted a prompt replica. A mobile sluggish fault is a sluggish replica that can move (is mobile) among the replicas.

In the case of sluggish replicas, safety cannot be guaranteed because a sluggish replica may not receive a certificate in the 2Δ time period, other replicas may not receive the sluggish replica's votes and resulting certificates and, the replica may not receive an equivocation in time if there is one.

The fifth embodiment modifies the fourth embodiment to allow for communications between replicas when some of them are sluggish.

The total number of faulty replicas allowed now includes sluggish replicas. Thus, if the number of sluggish replicas is d and the number of faulty replicas is b, then the total number of faulty replicas that can be tolerated is f=d+b. For example, if the total number of replicas is 5, then f=2, and there can be only one sluggish replica and one faulty replica. The remaining three replicas are prompt replicas. Therefore, in the example of five replicas, three of them must be prompt for a sufficiently long period of time.

To handle sluggish replicas, Vote function 304, Pre-commit function 306, and Commit function 308 are modified. Vote function 304 in the fifth embodiment is altered to eliminate the timer, which is moved to Pre-commit function 306, which now waits for a 2Δ time, starting upon receiving the proposal. Commit function 308 now waits for a commit from f+1 replicas, instead of the timer elapsing.

FIG. 28 depicts the flow of operations for the Vote function, in the fifth embodiment. Vote function 304 waits for a propose message <propose, Bₖ, v, C(Bₖ₋₁)> in step 2802, and if only one block Bₖ is proposed (no equivocation) as determined in step 2804, then the function sends a propose message <propose, Bₖ, v, C(Bₖ₋₁)> to all other replicas in step 2806 and then sends a vote message <vote, Bₖ, v> to all replicas in step 2808.

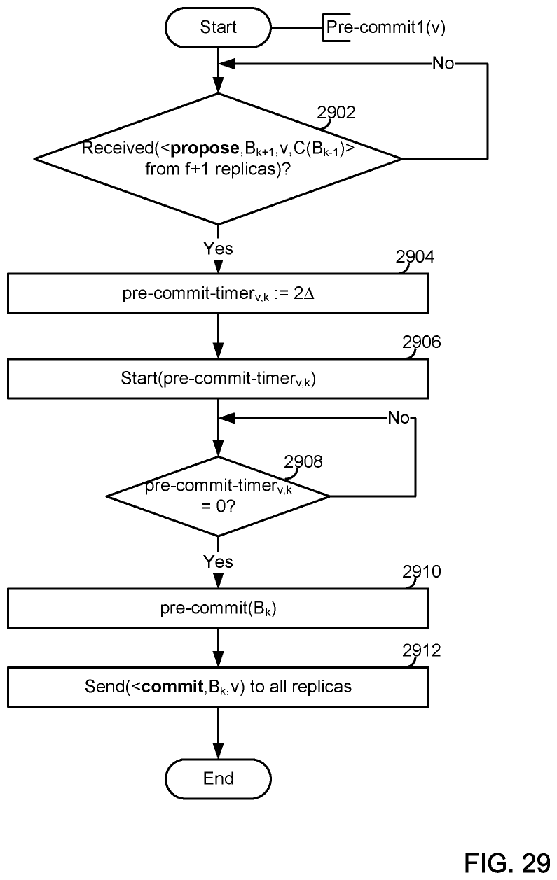

FIG. 29 depicts the flow of operations for the Pre-commit function, in the fifth embodiment. Pre-commit function 306 waits for a propose message <propose, Bₖ₊₁, v, C(Bₖ₋₁)> from f+1 replicas in step 2902. Upon receiving the f+1 propose messages, the function sets a pre-commit timer to 2Δ in step 2904 and starts the timer in step 2906. Upon the timer expiring (and thus waiting for a 2Δ time) as determined in step 2908, the function pre-commits the block Bₖ in step 2910 and then sends a commit message <commit, Bₖ, v> to all replicas in step 2912.

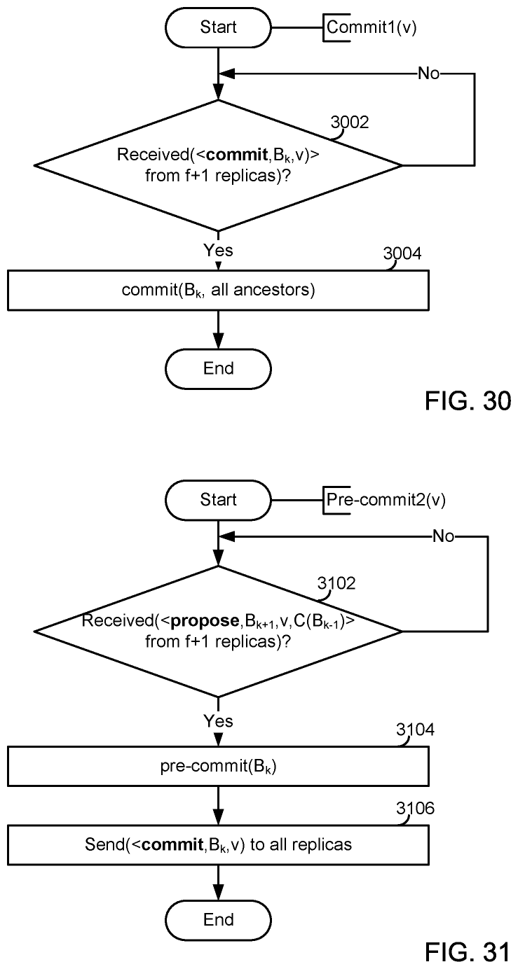

FIG. 30 depicts the flow of operations for the Commit function, in the fifth embodiment. Commit function 308 waits to receive a commit message <commit, Bₖ, v> from f+1 replicas in step 3002, after which it commits the block Bₖ and all ancestors of the Bₖ block in step 3004.

Safety and liveness are guaranteed in the fifth embodiment. Safety is guaranteed because f+1 honest replicas instead of all replicas are involved in both the Pre-commit function 306 and Commit function 308. Specifically, if an honest replica directly commits Bₗ in view v, then (i) no equivocating block is certified in view v and (ii) f+1 honest replicas lock on to a certified block that ranks equal to or higher than Cᵥ(Bₗ) before entering view v+1.

Liveness is guaranteed only during periods in which f+1 honest replicas, including the leader, stay prompt.

### Sixth Embodiment

FIGS. 31-35 refer to the flow of operations of the sixth embodiment, which is called the steady-state protocol in a responsive view.

The sixth embodiment modifies the fifth embodiment to allow for faster responses from replicas instead of waiting for the maximum network delay Δ. Pre-commit function 306, the Blame Function, the Status function, the New View function, and the First Vote function are altered. Pre-commit function 306 has no timer. The Blame function is altered to send blame2 messages. The Status function is altered to wait for blame2 messages from f+1 replicas. The New View function is altered to send a different new-view message. The First Vote function is altered to send a different new-view message.

FIG. 31 depicts the flow of operations for the Pre-commit function, in the sixth embodiment. Pre-commit function 306 waits for the propose message <propose, Bₖ₊₁, v, C(Bₖ₋₁)> to be received from f+1 replicas in step 3102. Upon receipt of the f+1 propose messages, the function pre-commits the block Bₖ in step 3104 and then sends a commit message <commit, Bₖ, v> for the block Bₖ to all replicas in step 3106.

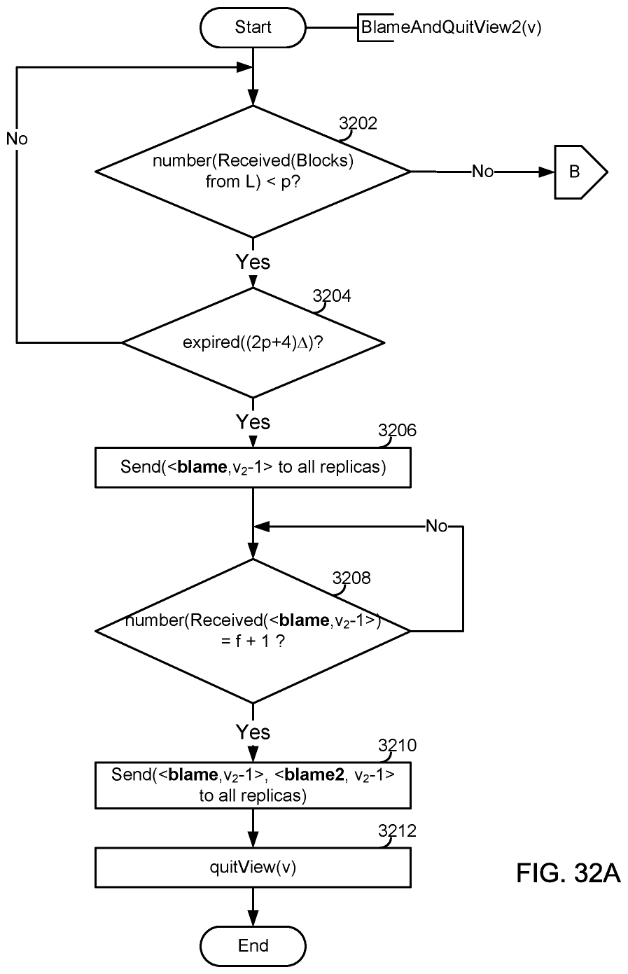

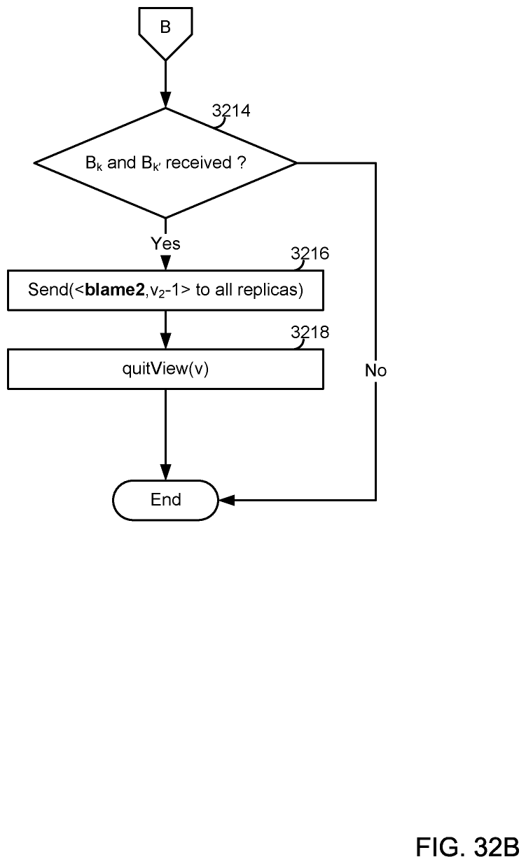

FIGS. 32A and 32B depict the flow of operations for the BlameAndQuitView function, in the sixth embodiment. The BlameAndQuitView function awaits receipt of a number of blocks greater than p from the leader in step 3202. If less than p blocks are received in a time period of (2p+4)Δ, then a stall condition has occurred as determined in steps 3202 and 3204, and the function sends a blame message <blame, v₂−1> to all replicas in step 3206. After sending the blame message, the function awaits blame messages <blame, v₂−1> from f+1 replicas in step 3208, and when that occurs, it sends blame and blame2 messages <blame, v₂−1>, <blame2, v₂−1> to all replicas in step 3210 and quits the current view in step 3212. The f+1 blame messages assure that at least one honest replica is sending a blame message. The blame 2 message includes the f+1 blame messages and assures that all replicas move to the next view. If p or more blocks are received, the function determines whether any of the received blocks are equivocating blocks in step 3214 of FIG. 32B (i.e., whether an equivocating condition has occurred) and, if so, sends a blame2 message <blame₂, v₂−1> to all replicas in step 3216 and quits the current view in step 3218.

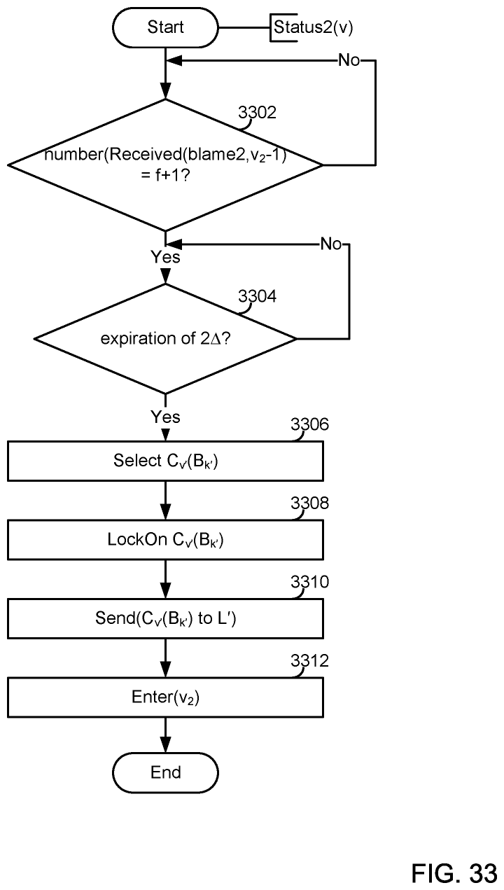

FIG. 33 depicts the flow of operations for the Status, in the sixth embodiment. The Status function awaits the receipt of f+1 blame2 messages <blame₂, v₂−1> in step 3302, and then waits for a 2Δ time in step 3304. After the 2Δ time, the function selects the highest certified block Cᵥ(B_{k′}) in step 3306, locks onto the selected block in step 3308, and sends the selected block to the new leader in step 3310. After sending the selected block, the function enters the new view in step 3312.

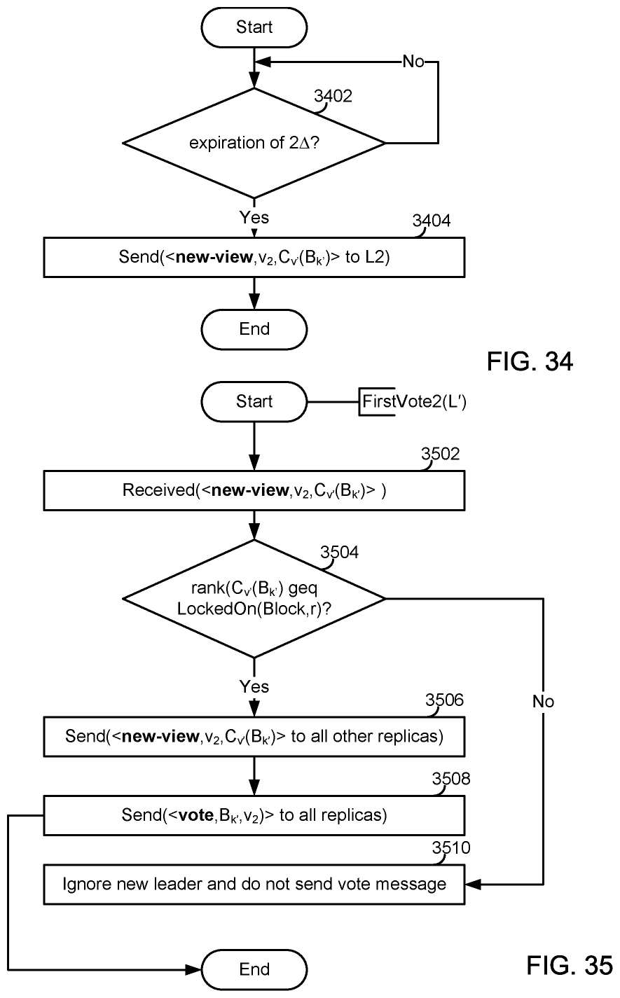

FIG. 34 depicts the flow of operations for the New-view function, in the sixth embodiment. The New-view function waits for the expiration of a 2Δ time in step 3402 and then sends a new-view message <new-view, v₂, Cᵥ(B_{k′})> to the new leader L2 in step 3404.

FIG. 35 depicts the flow of operations for the First Vote function, in the sixth embodiment. The First Vote function receives a new-view message <new-view, v₂, Cᵥ(B_{k′})> in step 3502 and then compares the message to the locked-on block in step 3504. If the rank of the block in the message is greater than or equal to the locked-on block, then the function sends a new-view message <new-view, v₂, Cᵥ(B_{k′})> to all the other replicas in step 3506, after which it sends a vote message <vote, Bₖ, v₂> to all replicas in step 3508. If the rank of the block in the message is less than the locked-on block as determined in step 3504, then the function ignores the new leader and does not send a vote message in step 3510.

Safety and liveness are guaranteed in the sixth embodiment. Safety is guaranteed for the same reasons as those given for the fifth embodiment. Liveness is guaranteed for the same reason as those given in regard to the fifth embodiment.

Thus, the above-described protocol is a practical and straightforward synchronous protocol allowing for a limited but larger number of faulty replicas than asynchronous protocols. The protocol does not require lockstep execution, tolerates mobile sluggish faults, and offers high throughput and low latency.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated.

Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system—computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs)—CD-ROM, a CDR, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for committing a block of client requests to a log of committed blocks in a distributed service that comprises N replicas deployed on compute nodes of a computer network, N being a positive integer, the method comprising:
receiving from one of the N replicas a proposal for committing to the log a block of client requests;
sending a vote on the proposed block to all of the replicas;
setting a timer to a delay that is twice a maximum transmission delay between any two compute nodes on the computer network and starting the timer; and
after the timer elapses and if there is neither an equivocation during the timer delay nor a stalling condition, committing the proposed block to the log if each replica is a prompt replica, which is a replica that responds to messages on the computer network within the delay of the timer.

2. The method of claim 1, further comprising:
during the delay of the timer, receiving from one of the N replicas another proposal for committing to the log another block of client requests, and sending a vote on the other proposed block.

3. The method of claim 1, wherein when a minority of replicas are sluggish replicas, where a sluggish replica is not responsive to messages on the computer network within the timer delay, said method further comprises:
if the replicas are not in a responsive mode after the timer elapses:
sending a commit message to all replicas;
waiting until receiving commit messages from a quorum of replicas; and
then committing the proposed block to the log.

4. The method of claim 3, when the minority of replicas are sluggish replicas, said method further comprises:
if the replicas are in the responsive mode and the majority of replicas responds faster than the timer delay:
waiting until receiving commit messages from a quorum of replicas; and
then committing the proposed block.

5. The method of claim 1, wherein the replica enters a responsive mode when a strong certificate is received in the proposal.

6. The method of claim 1, further comprising:
detecting the equivocation when a block that is received does not extend a block previously proposed; and
selecting a new leader in response to the detection of the equivocation.

7. The method of claim 1, further comprising:
detecting the stalling condition when a designated number of new blocks is not proposed within a designated time; and
selecting a new leader in response to the detection of the stalling condition.

8. The method of claim 6, wherein the designated time for p blocks is 2p+1 times the maximum transmission delay.

9. A computer system comprising:
one or more processors; and
a memory containing instructions that are executable on the processor of the computer system to carry out a method for committing a block of client requests to a log of committed blocks in a distributed service, the distributed service including N replicas deployed on compute nodes of a computer network, N being a positive integer, the computer system being one of the compute nodes, the method comprising:
receiving from one of the N replicas a proposal for committing to the log a block of client requests;
sending a vote on the proposed block to all of the replicas;
setting a timer to a delay that is twice a maximum transmission delay between any two compute nodes on the computer network and starting the timer; and
after the timer elapses and if there is neither an equivocation during the timer delay nor a stalling condition, committing the proposed block to the log if each replica is a prompt replica, which is a replica that responds to messages on the computer network within the delay of the timer.

10. The computer system of claim 9, wherein said method further comprises:
during the delay of the timer, receiving from one of the N replicas another proposal for committing to the log another block of client requests, and sending a vote on the other proposed block.

11. The computer system of claim 9, wherein when a minority of replicas are sluggish replicas, where a sluggish replica is not responsive to messages on the computer network within the timer delay, said method further comprises:
if the replicas are not in a responsive mode after the timer elapses:
sending a commit message to all replicas;
waiting until receiving commit messages from a quorum of replicas; and
then committing the proposed block to the log.

12. The computer system of claim 11, wherein when the minority of replicas are sluggish replicas, said method further comprises:
if the replicas are in the responsive mode and the majority of replicas responds faster than the timer delay:
waiting until receiving commit messages from a quorum of replicas; and
then committing the proposed block.

13. The computer system of claim 9, wherein the replica enters a responsive mode when a strong certificate is received in the proposal.

14. The computer system of claim 9, wherein said method further comprises:
detecting the equivocation when a block that is received does not extend a block previously proposed; and
selecting a new leader in response to the detection of the equivocation

15. The computer system of claim 9, wherein said method further comprises:
detecting that the stalling condition has occurred when a designated number of new blocks is not proposed within a designated time; and
selecting a new leader in response to the detection of the stalling condition.

16. The computer system of claim 15, wherein the designated time for p blocks is 2p+1 times the maximum transmission delay.

17. A non-transitory computer-readable medium comprising instructions that are executable on a processor of a computer system, wherein the instructions, when executed on the processor, cause the computer system to carry out a method for committing a block of client requests to a log of committed blocks in a distributed service that comprises N replicas deployed on compute nodes of a computer network, N being a positive integer, the method comprising:
receiving from one of the N replicas a proposal for committing to the log a block of client requests;
sending a vote on the proposed block to all of the replicas;
setting a timer to a delay that is twice a maximum transmission delay between any two compute nodes on the computer network and starting the timer; and
after the timer elapses and if there is neither an equivocation during the timer delay nor a stalling condition, committing the proposed block to the log if each replica is a prompt replica, which is a replica that responds to messages on the computer network within the delay of the timer.

18. The non-transitory computer-readable medium of claim 17, wherein said method further comprises:
during the delay of the timer, receiving from one of the N replicas another proposal for committing to the log another block of client requests, and sending a vote on the other proposed block.

19. The non-transitory computer-readable medium of claim 17, wherein said method further comprises:
detecting the equivocation when a block that is received does not extend a block previously proposed; and
selecting a new leader in response to the detection of the equivocation.

20. The non-transitory computer-readable medium of claim 17, wherein said method further comprises:
detecting that the stalling condition has occurred when a designated number of new blocks is not proposed within a designated time; and
selecting a new leader in response to the detection of the stalling condition, wherein the designated time for p blocks is 2p+1 times the maximum transmission delay.
